(19) United States
(12) Patent Application Publication
(10) Pub. No.: US 2010/0269097 A1
(43) Pub. Date: Oct. 21, 2010

(54) SCRIPTING LANGUAGE ASSEMBLER EXIT

(75) Inventor: Richard Rozentals, Pickering (CA)

Correspondence Address: SCHWEGMAN, LUNDBERG & WOESSNER, P.A., P.O. BOX 2938, MINNEAPOLIS, MN, 55402, US

(73) Assignee: CA, Inc., Islandia, NY (US)

(21) Appl. No.: 12/427,489

(22) Filed: Apr. 21, 2009

(51) Int. Cl. G06F 9/44

(52) U.S. Cl. 717/114

(57) ABSTRACT

A computer implemented method and system exit to an assembler exit while executing an application on the computer. A REXX exec is initiated with an address pointer to assembler variables on the computer. A first function executing on the computer is called to unload the variables to a REXX format using a seed. REXX statements are executed to modify at least one variable. A second function is then called to reload the REXX variable to the address as per the seed.

### BACKGROUND

An assembly language is a low-level language for programming computers. It implements a symbolic representation of the numeric machine codes and other constants needed to program computer hardware. The symbolic representation is usually defined by a hardware manufacturer and helps programmers work with individual instructions, registers, etc.

Assembly languages eliminate much of the error-prone and time-consuming programming needed to directly manipulate the hardware, provide access to specialized processor instructions, or to address critical performance issues. Typical uses are device drivers, low-level embedded systems, and real-time systems.

A utility program called an assembler may be used to translate assembly language statements into the target hardware machine language. Many older higher level software products have an assembler exit point. Assembler skills are in short supply, and the learning curve is long. This makes it difficult to use features provided by the assembly language.

### SUMMARY

A computer implemented method exits to an assembler exit while executing an application on the computer. A REXX exec is initiated with an address pointer to assembler variables on the computer. A first function executing on the computer is called to unload the variables to a REXX format using a seed. REXX statements are executed to modify at least one variable. A second function is then called to reload the REXX variable to the address as per the seed.

In one embodiment, a computer implemented method exits to an assembler exit while executing an application on the computer. A REXX environment is then initiated on the computer. A REXX exec is initiated within the REXX environment with an address pointer to assembler variables stored on a storage device in the computer. The REXX exec calls a first function executing on the computer to unload the variables to a REXX format using a seed. REXX statements are then executed in the REXX exec that modify at least one variable. The REXX exec then calls a second function to reload the REXX variable to the address as per the seed. Control is passed back to the assembler exit in the application executing on the computer.

A system includes an assembler exit executing on a computer having executable code corresponding to an application stored on a storage device associated with the computer. A REXX environment stored on a storage device associated with the computer is initiated via the assembler exit when the assembler exit is encountered by the application. A REXX exec is stored on a storage device associated with the computer and having an address pointer to assembler variables stored on a storage device associated with the computer. The REXX exec has stored code for calling a first function executing on the computer to unload the variables to a REXX format using a seed, executing REXX statements that modify at least one variable. The REXX exec further calls a second function to reload the REXX variable to the address as per the seed.

### BRIEF DESCRIPTION OF THE DRAWINGS

FIG. 1 is a block flow chart illustrating a method of performing an assembler exit in an application program according to an example embodiment.

FIG. 2 is a block diagram of a computer system for executing a method of performing an assembler exit according to an example embodiment.

FIG. 3 is a block diagram of a computer system illustrating components for performing an assembler exit according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

In various embodiments, an assembler exit is extended to facilitate exit coding in a high level language, such as REXX (REstructured eXtended eXecutor). The high level language may be used to code the exit without having to use a significant amount of extra code to load/save the high level language variables. A user may use the high level language code for the exit, or continue to use the assembler exit.

REXX is an interpreted programming language. It is a structured high-level programming language which was designed to be both easy to learn and easy to read. Both proprietary and open source interpreters for REXX are available on a wide range of computing platforms.

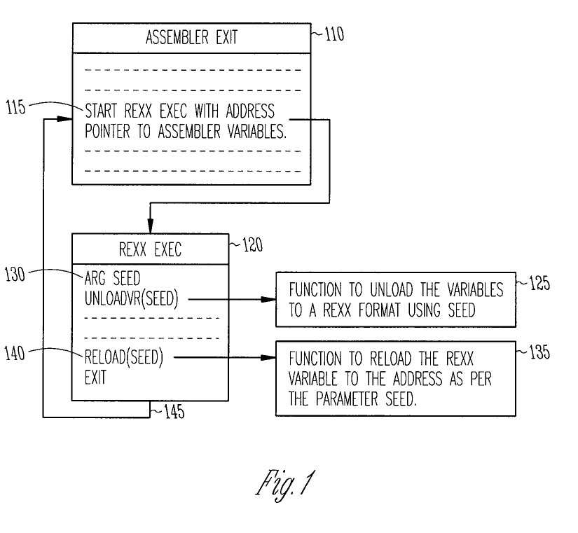

In FIG. 1, an application running on a computer system invokes an assembler exit at 110. In one embodiment, exit coding has been done in a high level language such as REXX. A REXX exec is initiated by the assembler exit at an assembler call 115 with an address pointer to assembler variables. The REXX exec is indicated at 120, and calls a function 125 to unload variables to a REXX format using a seed. The seed is provided by a call to the function at 130 consisting of ARG SEED UNLOADVR(SEED). The function 125 loads the variables to the address point to be used by a remaining part of the assembler exit.

REXX instructions may then be executed to manipulate hardware, provide access to specialized processor instructions, or to address critical performance issues. Typical uses are device drivers, low-level embedded systems, and real-time systems. A second function 135 is then used to reload the REXX variable to the address as per a parameter SEED. This function is called at 140 by RELOAD(SEED). In various embodiments, an application vendor sets up the assembler exit and two functions. A customer of the vendor codes the exit in REXX. The REXX exec is then exited at 145 to return to the assembler exit 110 at a point corresponding to the initiation of the exit.

In a further embodiment, the existing assembler exit 110 is altered to save the address of where the variables are stored. The assembler exit may then call a utility that starts a REXX environment at 120, such as IRXEXE by IBM Corporation. A parameter is passed to the REXX exec, which corresponds to the address of where the variables will start. In the REXX exec, the parameter will be accepted and then the function 125 to load the variables may be called. In one embodiment, a utility such as IRXEXCOM by IBM Corporation may be used to load the variables so that they can be read and written by the REXX exec. The REXX exec 120 then performs desired methods that may include logic to check/alter the variables. At the end of the REXX exec 120, another function 135 may be run to load the variables back to the address. Control then goes back to the assembler function in the assembler exit.

REXX can be coded by the user for exit points in the application being run. The use of high level language such as REXX has a shorter learning curve than an assembly language, making it easier to use. It may also reduce the time needed to set up software application products in different user environments. The user is not required to know anything about how variables get into the REXX exec. To load and unload variables need only utilize three REXX statements. The method may be used by any software product that requires assembler, Cobol, or PL1 exit points. The changes to code for different exit points may be minimal.

The present method differs from prior methods of passing variables as parameters with no passing back of altered variables, and the passing of addresses of the variables and use of REXX to load each variable, as it uses a function to load variables. The use of functions to load variables limits chances for errors and adds more ability to pass back items. Also, variables may be added without any changes to the REXX exec. The present method is simple and easy to support. It also uses much less code than other methods.

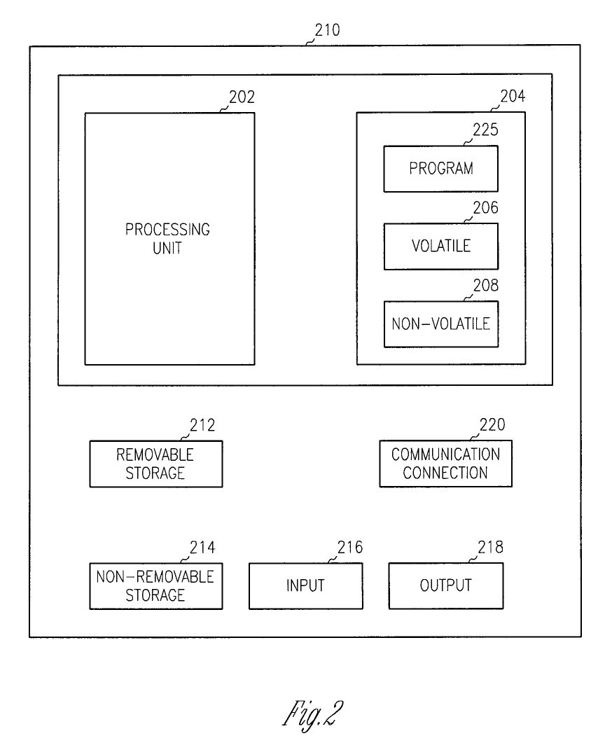

A block diagram of a computer system that executes programming for running an application product, the assembler exit, REXX exec and functions is shown in FIG. 2. A specifically programmed computing device in the form of a computer 210, may include a processing unit 202, memory 204, removable storage 212, and non-removable storage 214. Memory 204 may include volatile memory 206 and non-volatile memory 208. Computer 210 may include - or have access to a computing environment that includes—a variety of computer-readable media, such as volatile memory 206 and non-volatile memory 208, removable storage 212 and non-removable storage 214. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 210 may include or have access to a computing environment that includes input 216, output 218, and a communication connection 220. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 202 of the computer 210. A hard drive, CD-ROM, and RAM are some examples of articles including a computer-readable medium.

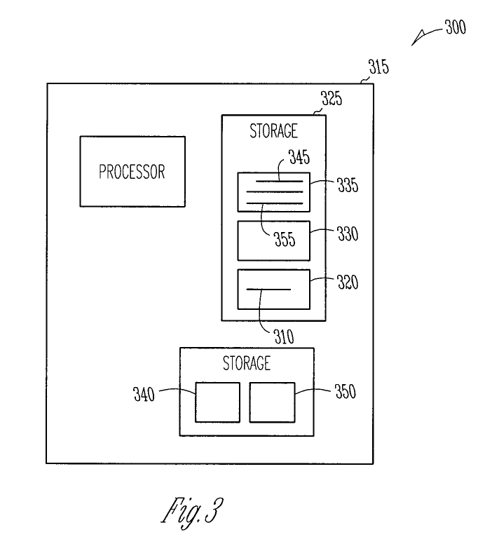

FIG. 3 is a block diagram of a system 300 that includes an assembler exit 310 executing on a computer 315 having executable code corresponding to an application 320 stored on a storage device 325 associated with the computer 315. A REXX environment 330 stored on a storage device associated with the computer 315 may be initiated via the assembler exit 310 when the assembler exit is encountered by the application 320.

A REXX exec 335 may be stored on a storage device associated with the computer 315 and may have an address pointer to assembler variables stored on a storage device associated with the computer 315. The REXX exec 335 has stored code for calling a first function 340 executing on the computer 315 to unload the variables to a REXX format using a seed. REXX statements 345 may be executed to modify at least one variable. A second function 350 may be called to reload the REXX variable to the address as per the seed.

In one embodiment, the REXX exec 335 has stored code 355 for passing control back to the assembler exit following the calling of the second function 350. The first function 340 may operate to load the variables to an address point to be used during execution of the REXX statements 345. In one embodiment, the REXX statements 345 are executed to manipulate hardware, provide access to specialized processor instructions, or to address critical performance issues. In a further embodiment, the REXX statements 345 comprise at least one of device drivers, low-level embedded systems, and real-time systems. The above storage devices may be the same storage device or different storage devices associated with computer 315. Examples include internal and external memory or storage devices and networked memory or storage devices that may be accessed by computer 315.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A computer implemented method comprising:
exiting to an assembler exit while executing an application on the computer;
initiating a REXX exec with an address pointer to assembler variables on the computer;
calling a first function executing on the computer to unload the variables to a REXX format using a seed;
executing REXX statements that modify at least one variable; and
calling a second function to reload the REXX variable to the address as per the seed.

2. The method of claim 1 and further comprising passing control back to the assembler exit.

3. The method of claim 1 wherein the first function loads the variables to an address point to be used during execution of the REXX statements.

4. The method of claim 1 wherein the REXX statements are executed to manipulate hardware, provide access to specialized processor instructions, or to address critical performance issues.

5. The method of claim 1 wherein the REXX statements comprise at least one of device drivers, low-level embedded systems, and real-time systems.

6. The method of claim 1 wherein the assembler exit saves the address of where the variables are stored.

7. The method of claim 6 wherein a parameter is passed to the REXX exec, which corresponds to the address of where the variables will start.

8. The method of claim 1 wherein the assembler exit initiates a REXX environment.

9. The method of claim 1 wherein the REXX exec perform a method that includes include logic to at least check or alter the variables.

10. A computer implemented method comprising:
exiting to an assembler exit while executing an application on the computer;
initiates a REXX environment on the computer;
initiating a REXX exec within the REXX environment with an address pointer to assembler variables stored on a storage device in the computer;
the REXX exec calling a first function executing on the computer to unload the variables to a REXX format using a seed;
executing REXX statements in the REXX exec that modify at least one variable;
the REXX exec calling a second function to reload the REXX variable to the address as per the seed; and
passing control back to the assembler exit in the application executing on the computer.

11. The method of claim 10 wherein the first function loads the variables to an address point to be used during execution of the REXX statements.

12. The method of claim 10 wherein the REXX statements are executed to manipulate hardware, provide access to specialized processor instructions, or to address critical performance issues.

13. The method of claim 10 wherein the REXX statements comprise at least one of device drivers, low-level embedded systems, and real-time systems.

14. The method of claim 10 wherein the assembler exit saves the address of where the variables are stored.

15. The method of claim 14 wherein a parameter is passed to the REXX exec, which corresponds to the address of where the variables will start.

16. A system comprising:
an assembler exit executing on a computer having executable code corresponding to an application stored on a storage device associated with the computer;
a REXX environment stored on a storage device associated with the computer that is initiated via the assembler exit when the assembler exit is encountered by the application;
a REXX exec stored on a storage device associated with the computer and having an address pointer to assembler variables stored on a storage device associated with the computer, wherein the REXX exec has stored code for calling a first function executing on the computer to unload the variables to a REXX format using a seed, executing REXX statements that modify at least one variable, and calling a second function to reload the REXX variable to the address as per the seed.

17. The system of claim 16 wherein the REXX exec has stored code for passing control back to the assembler exit following the calling of the second function.

18. The system of claim 16 wherein the first function loads the variables to an address point to be used during execution of the REXX statements.

19. The system of claim 16 wherein the REXX statements are executed to manipulate hardware, provide access to specialized processor instructions, or to address critical performance issues.

20. The system of claim 16 wherein the REXX statements comprise at least one of device drivers, low-level embedded systems, and real-time systems.
